(19) United States
(12) Patent Application Publication
(10) Pub. No.: US 2024/0020115 A1
(43) Pub. Date: Jan. 18, 2024

(54) SMART ONLINE DOCUMENTATION

(71) Applicant: Dell Products L.P., Round Rock, TX (US)

(72) Inventors: Ming Qian, Allston, MA (US); Robert Barrett, Austin, TX (US); Nicole Reineke, Northborough, MA (US)

(21) Appl. No.: 17/812,526

(22) Filed: Jul. 14, 2022

(51) Int. Cl. G06F 8/73; H04L 67/306

(52) U.S. Cl. CPC G06F 8/73; H04L 67/306

(57) ABSTRACT

A system can associate respective tags with respective online documentation content. The system can track user events in interacting with a user interface, wherein the user events are associated with a user account. The system can determine respective scores for respective tags based on the user events and the respective tags. The system can present first online documentation content of the respective online documentation content with the user account based the first online documentation content corresponding to a first tag of the respective tags having a first score of the respective scores that is determined to be above a defined threshold value.

### BACKGROUND

Computer programs and services can have associated documentation, which can educate a user on how to use the program or service.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can associate respective tags with respective online documentation content. The system can track user events in interacting with a user interface, wherein the user events are associated with a user account. The system can determine respective scores for respective tags based on the user events and the respective tags. The system can present first online documentation content of the respective online documentation content with the user account based the first online documentation content corresponding to a first tag of the respective tags having a first score of the respective scores that is determined to be above a defined threshold value.

An example method can comprise tracking, by a system comprising a processor, user events in an interaction with a user interface, wherein the user events are associated with a user account. The method can further comprise determining, by the system, respective scores for respective tags for online documentation content based on the user events and the tags. The method can further comprise presenting, by the system, first online documentation content of the online documentation content with the user account based the first online documentation content corresponding to a first tag of the tags being determined to have a first score of the scores that is above a determined threshold value.

An example non-transitory computer-readable medium can comprise instructions that, in response to execution, cause a system comprising a processor to perform operations. These operations can comprise tracking user events comprised in an interaction with a user interface, the interaction being associated with a user account. These operations can further comprise determining respective scores for respective tags for respective online documentation content based on the user events and the tags. These operations can further comprise presenting online documentation content of the respective online documentation content with the user account based the online documentation content corresponding to a first tag of the tags being determined to have a first score of the scores that is above a specified threshold value.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate smart online documentation, in accordance with an embodiment of this disclosure;

FIG. 2 illustrates an example system architecture for end-user and backend flow that can facilitate smart online documentation, in accordance with an embodiment of this disclosure;

FIG. 3 illustrates an example system architecture for documentation prioritization that can facilitate smart online documentation, in accordance with an embodiment of this disclosure;

FIG. 4 illustrates an example system architecture for smart documentation setup flow that can facilitate smart online documentation, and a tags creation and association process, in accordance with an embodiment of this disclosure;

FIG. 5 illustrates another example system architecture that can facilitate smart online documentation, in accordance with an embodiment of this disclosure;

FIG. 6 illustrates an example system architecture for a smart online documentation backend that can facilitate smart online documentation, in accordance with an embodiment of this disclosure;

FIG. 7 illustrates an example system architecture for determining a score that can facilitate smart online documentation, in accordance with an embodiment of this disclosure;

FIG. 8 illustrates an example process flow that can facilitate smart online documentation, in accordance with an embodiment of this disclosure;

FIG. 9 illustrates another example process flow that can smart online documentation, in accordance with an embodiment of this disclosure;

FIG. 10 illustrates another example process flow that can facilitate smart online documentation, in accordance with an embodiment of this disclosure;

FIG. 11 illustrates an example block diagram of a computer operable to execute an embodiment of this disclosure.

### DETAILED DESCRIPTION

### Overview

It can be that users seldom read online documentation from beginning to end. It can be a problem that documentation is not targeted to match how users interact with a product.

The present techniques can address this problem by determining a score that takes into account different factors/weightings that can impact how a user will interact with online documentation. The present techniques can improve usability for online documentation by analyzing and capturing how users interact with a product.

The present techniques can be implemented to map data to a pre-defined, product-specific event model. The present techniques can be implemented to map data to a pre-defined, product-specific online documentation model. The present techniques can be implemented to automatically adjust top-level and content-level pages within online documentation such that users can find what they want quickly.

Expert users can care more about specific sections of online documentation, for example sections for which they are unfamiliar, or sections that are relevant to troubleshooting within specific context(s). On the other hand, novice users can have a hard time consuming online documentation, because of the broad scope of content the online documentation provides can be overwhelming based on their limited experience with usage of the product.

The present techniques can be implemented to improve usability of online documentation by analyzing product usage, mapping that usage to product-specific defined usage event model, then translating that model to a product-specific defined online documentation model such that the documentation automatically adjusts its top-level and content-level pages to assist users in finding help topics they need in a proactive manner. This approach can be an improvement over present techniques, which require uses to perform a more passive, manual discovery workflow (e.g., search, browse, read).

A problem with prior approaches to online documentation can be that the structure of online documentation does not address different levels of user expertise, different usage content, past usage, or topics of interest.

Another problem with prior approaches to online documentation can be that events triggered from product (user and/or system generated) and usage of online documentation is not tracked or stored in a linked manner, nor is linked data being analyzed to optimize online documentation.

These problems can lead to information overload when users are looking for help. Online documentation systems can offer help for hundreds of product features, but it can be that most users only use a subset of those features. It can be that those users are not concerned with navigating around topics irrelevant to them.

It can be that an information architecture for online documentation is not specific enough to match how users interact with an associated product. That is, there can be a disconnect between product usage and product documentation. Prior approaches to online documentation can fail to consider actual user touchpoints and interactions with associated product, which can create a problem of information overload, and can increase an amount of time and effort required by a user to find appropriate documentation.

There can be a lack of custom help and documentation content based on user interactions. It can be that user's interaction with help is not tracked to improve the general help experience. For example, forcing users to sift through lengthy introduction sections and paragraphs for topics that they are already familiar with can be more distracting than helpful. Conversely, a user without any prior experience with a concept can get too much information when, in fact, it would be helpful to prioritize an introduction-style or “quick start” type of material.

The present techniques can be implemented to mitigate against these problems with prior approaches to online documentation. The present techniques can implement a tagging and matching mechanism as described herein.

The present techniques can be implemented to:
Define help tags associated with all usage events in a console, including infrastructure events, console events, and manual (user-triggered) action events.
Map tracked and stored events with associated help tags.
Weight help tags based on factors such as chronological order and frequency of usage events.
Improve online documentation by matching and prioritizing appropriate general navigation, top documentation topics, links to documentation, and specific content sections within documentation pages to match users' intent and circumstances.

According to the present techniques, help can be presented in a dynamic way that matches with actual product usage, such that users are not overloaded with online documentation information that is not pertinent to product usage. According to the present techniques, customized information architecture and documentation articles can be matched with user intention. According to the present techniques, customized documentation and help content can further be refined based on product usage.

Consider an example of an experienced/authenticated user who frequently uses a console to conduct technical operations.

Experienced/authenticated users can use multiple functions in the console and receive multiple alerts. After viewing an alert of a specific type, an experienced user can navigate to online documentation to look for help material that can help with remediating the issue identified by the alert.

When a user opens a documentation page, the general navigation for help can be optimized based on the user's general console usage, such as by reorganizing the sections of a catalog. In addition, the top three potential topics based on the user's general console usage and last action (which is checking the alert for a particular object) can be displayed front and center to the user on a landing page.

If the user clicks on the first topic (related to a specific type of error code), that can take the user to the documentation page that describes technical specifics about this alert. Documentation content can be automatically adjusted based on this experienced user's usage within a console, and the user's familiarity of the related issue. For example, when the system knows that this particular user is an expert user of the console and has dealt with similar alert issues before, the displayed content of the documentation can promote advanced help content while demoting introductory sections and sections on basic configurations.

Consider an example of a novice user with limited console experience who uses only basic features.

A novice user who is not very familiar with the console might receive an alert (in the console). After viewing the alert, the user can go to the online documentation to look for help content that could assist in remediating the issue.

When the novice user opens the documentation page, the general navigation for help can be optimized based on the user's general console usage, which in this case, the general navigation promotes more basic help information, as opposed to promoting advanced materials to expert users. In addition, the top three potential topics based on their general console usage and their last action (which is checking an alert associated with a particular object) are displayed front and center in the user interface on the landing page.

If the user clicks on the first topic (related to a specific type of error code), the user can be taken to the documentation page that describes the technical specifics about this alert. The documentation content can be adjusted based on this user's novice usage in the console and the user's familiarity of the related issue, which in this case is that this user has never dealt with this issue before. Finally, the displayed content of the documentation article can automatically promote content such as introductory and basic configuration sections, and training videos as appropriate for this novice user.

### Example Architectures

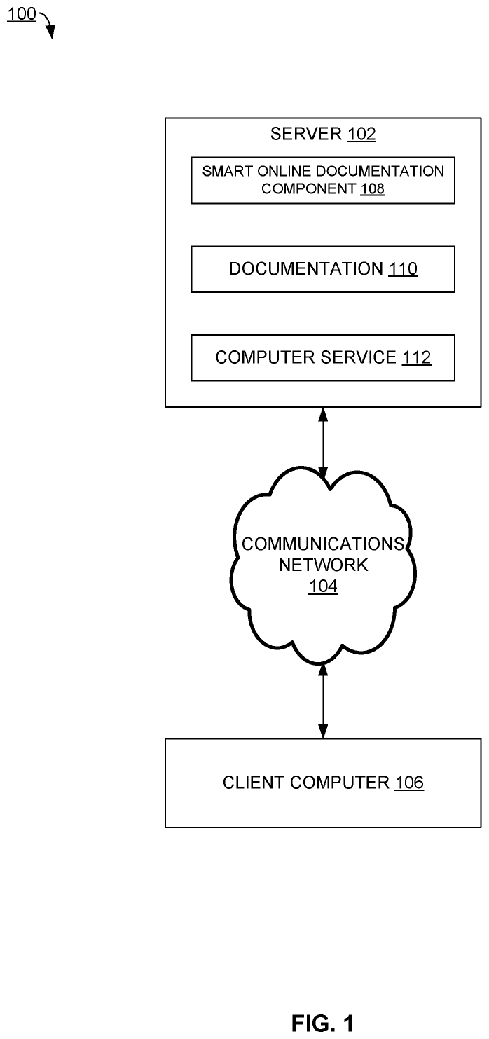

FIG. 1 illustrates an example system architecture 100 that can facilitate smart online documentation, in accordance with an embodiment of this disclosure.

System architecture 100 comprises server 102, communications network 104, and user computer 106. In turn, server 102 comprises smart online documentation component 108, documentation 110, and computer service 112.

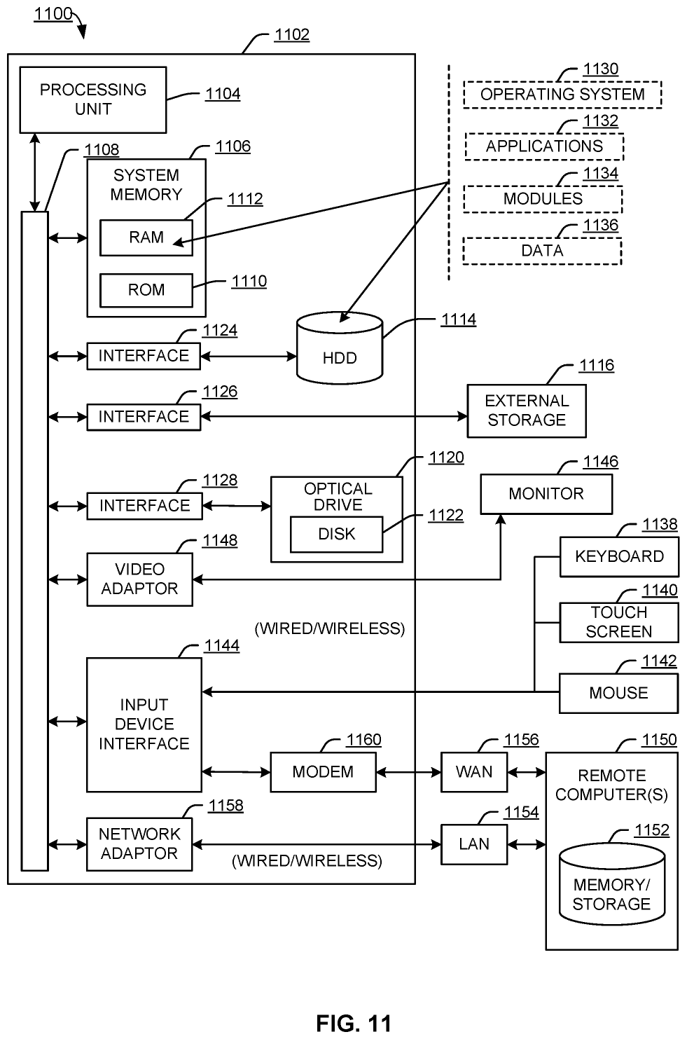

Each of server 102 and/or user computer 106 can be implemented with part(s) of computing environment 1100 of FIG. 11. Communications network 104 can comprise a computer communications network, such as the Internet.

A user can use user computer 106 to access a service provided by computer service 112 (e.g., a console). Smart online documentation component 108 can track user events that occur as part of user computer 106 accessing computer service 112. When the user of user computer 106 then accesses documentation relating to computer service 112, smart online documentation component 108 can select what documentation of documentation 110 to present to client computer, and how to present it (e.g., how arranged within a user interface).

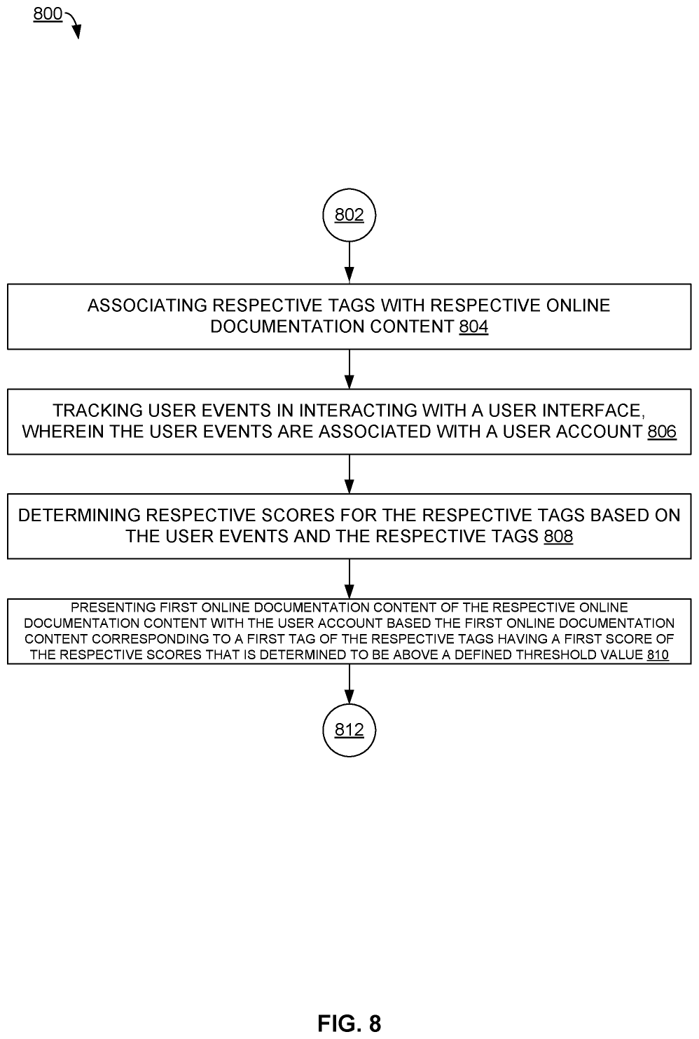

In some examples, smart online documentation component 108 can implement part(s) of the process flows of FIGS. 8-10 to implement smart online documentation.

It can be appreciated that system architecture 100 is one example system architecture for smart online documentation, and that there can be other system architectures that facilitate smart online documentation.

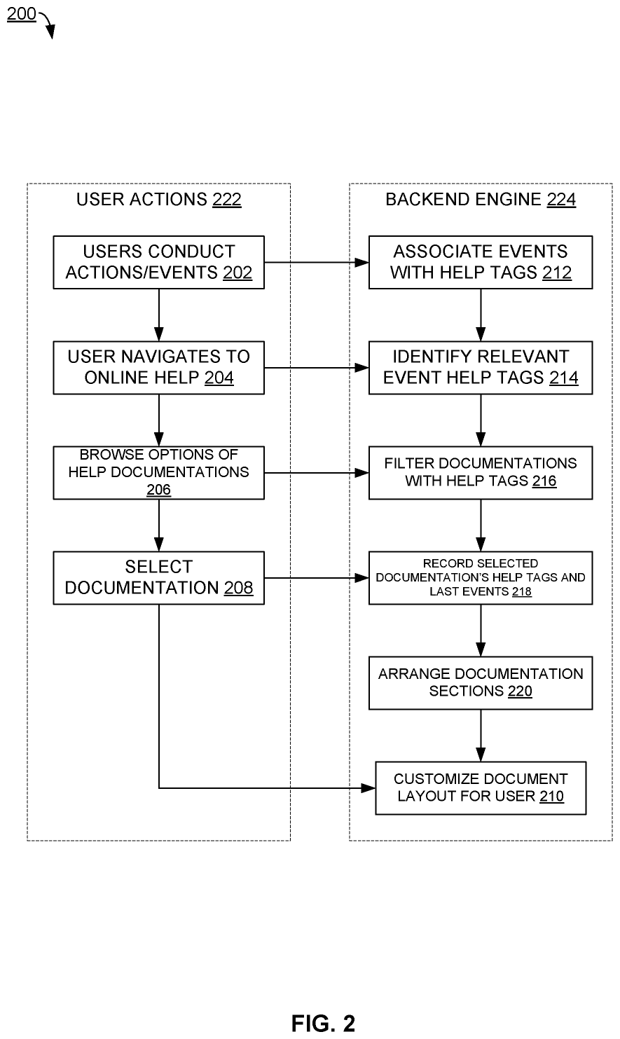

FIG. 2 illustrates an example system architecture 200 for end-user and backend flow that can facilitate smart online documentation, in accordance with an embodiment of this disclosure. In some examples, part(s) of system architecture 200 can be implemented by smart online documentation component 108 of FIG. 1.

System architecture 200 comprises users conduct actions/events 202; user navigates to online help 204; browse options of help documentations 206; select documentation 208; customize document layout for user 210; associate events with help tags 212; identify relevant event help tags 214; filter documentations with help tags 216; record selected documentation's help tags and last events 218; arrange documentation sections 220; user actions 222, and backend engine 224.

User actions 222 can comprise actions performed by a user in accessing smart online documentation. Backend engine 224 can be similar to smart online documentation component 108 of FIG. 1.

Users conduct actions/events 202 can comprise multiple user actions/events that can occur across multiple sessions with a computer service. With respect to users conduct actions/events 202, in an example where the computer service is a console, smart online documentation component 108 can track console usage (leveraging existing analytics tracking) as well as track alert logs.

User navigates to online help 204 can comprise a user account accessing help documentation that is associated with the computer service. Browse options of help documentations 206 can comprise the user account navigating through help documentation options. Select documentation 208 can comprise the user account selecting a specific help documentation from among the options of 206. Customize document layout for user 210 can comprise the user account receiving a customized layout of help documentation according to the present techniques.

Associate events with help tags 212 can comprise smart online documentation component maintaining a database that associates particular types of events with help tags. Identify relevant event help tags 214 can comprise identifying a most relevant event help tag for a user account based on the actions/events of 202. In some examples, this can be performed before a user account attempts to access online help documentation. In some examples, this can be determined based on timestamps and/or event frequencies to determine most-relevant event help tags. This can comprise checking error logs, usage logs, system event logs, and logs associated with the computing service.

Filter documentations with help tags 216 can involving filtering documentations with the associated event help tags to determine a list of documentations that are most relevant. In some examples, a final filter can be performed based on a help tag associated with the last event of 202. Filter documentations with help tags 216 can comprise showing the top-three things that smart online documentation component 108 determines that the user account could use help with.

Record selected documentation's help tags and last events 218 can be performed to further train a model that implements the present techniques, such as to update associate events with help tags 212. Arrange documentation sections 220 can involve arranging documentation sections with associated help tags in a relevant manner.

Using system architecture 200, user actions and events from current and previous console sessions can be captured and stored in a backend database for analysis and filtering.

Consider the following example. A user checks an alert in the console and has difficulty understanding how to interpret the alert. The user then navigates to online documentation for help. The backend can track the combined action of “user reaching out for help immediately after looking at an alert.” When the online documentation opens, the backend can check for events based on a time stamp function to determine a last action the user conducted before the time stamp where the user clicks into the help/documentation page. This particular event (the last action before help) can be assigned a higher weight in the matching pattern described herein.

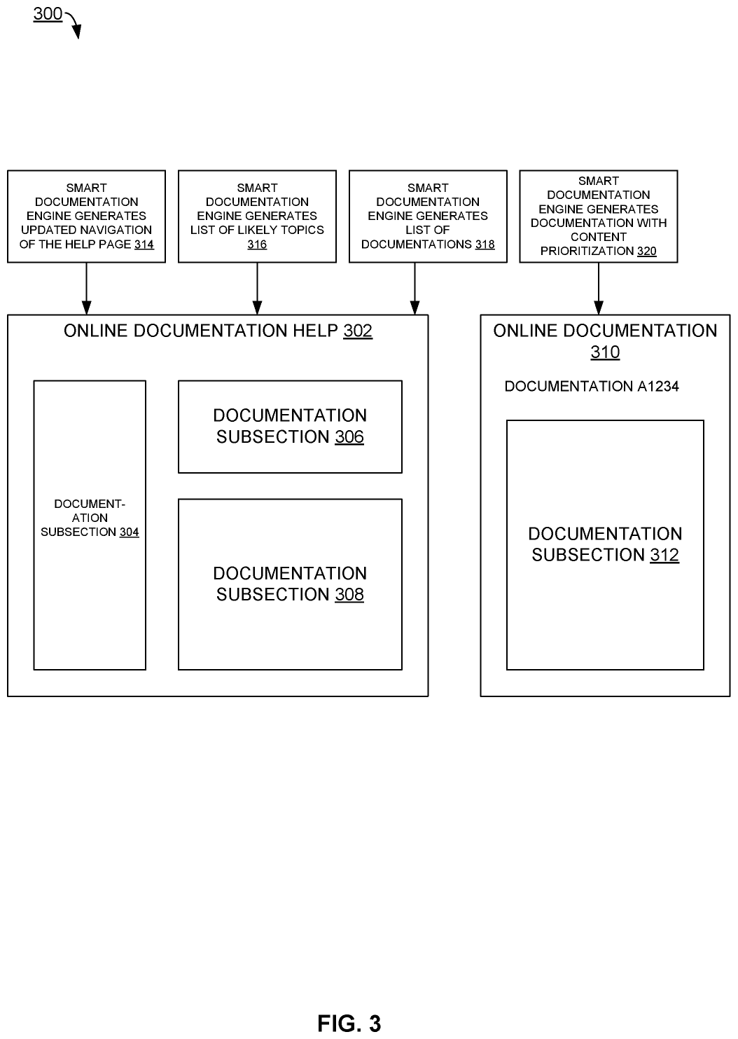

FIG. 3 illustrates an example system architecture 300 for documentation prioritization that can facilitate smart online documentation, in accordance with an embodiment of this disclosure. In some examples, part(s) of system architecture 300 can be implemented by smart online documentation component 108 of FIG. 1.

System architecture 300 comprises online documentation help 302; documentation subsection 304; documentation subsection 306; documentation subsection 308; online documentation 310; documentation subsection 312; smart documentation engine generates updated navigation of the help page 314; smart documentation engine generates list of likely topics 316; smart documentation engine generates list of documentations 318; and smart documentation engine generates documentation with content prioritization 320.

Documentation subsection 304 can comprise a navigation portion of online documentation help 302 and can be generated by smart documentation engine generates updated navigation of the help page 314. Documentation subsection 306 can comprise a most-likely topics portion of online documentation help 302 and can be generated by smart documentation engine generates list of likely topics 316. Documentation subsection 308 can comprise a list of documentations of online documentation help 302 and can be generated by smart documentation engine generates list of documentations 318.

Documentation subsection 312 can comprise content presented in a prioritized order of online documentation 310 and can be generated by smart documentation engine generates documentation with content prioritization 320.

In system architecture 300, there can be a relationship between various parts—304 and 314, 306 and 316, 308 and 318, and 312 and 320. As depicted, 304 is documentation subsection—navigation items (314). 306 is documentation subsection list of likely topics (316). 308 is documentation subsection—list of documentations (318). 312 is documentation subsection—documentation with content prioritization (320).

Users can start using online documentation. In some examples, documentation pages can be prioritized in four main ways for a user based on the user's past usage of the console that was collected in the backend.

A documentation page's navigation (e.g., documentation subsection 304) can be adjusted to promote the right content to meet a particular user's need and expertise level. For example, relevant topics can move to the top.

Top potential topics (e.g., documentation subsection 306) that the users might care about can be promoted front and center. For example, hyperlinks to top three suggested help topics can be automatically generated.

The documentation articles (e.g., documentation subsection 308) can be prioritized based on the selected topics in sequence of relevance. For example, a list of articles related to suggested help topics can be presented on the home screen.

The selected documentation content (e.g., documentation subsection 312) can be prioritized based on a user's console usage, needs, and expertise level. For example, the documentation page for a specific alert type can prioritize the introductory content section and deprioritize advanced content section(s) because based on analytics, the user is likely looking for basic level support.

Through this approach, a user can reach the most relevant documentation in a dramatically simplified manner relative to prior approaches.

In addition, documentation that the user selects (along with associated help tag(s) and the last event(s) that the user triggered before interacting with help) can again be stored to a database historian for future analysis and prediction, which can facilitate continually fine-tuning smart-help predictions.

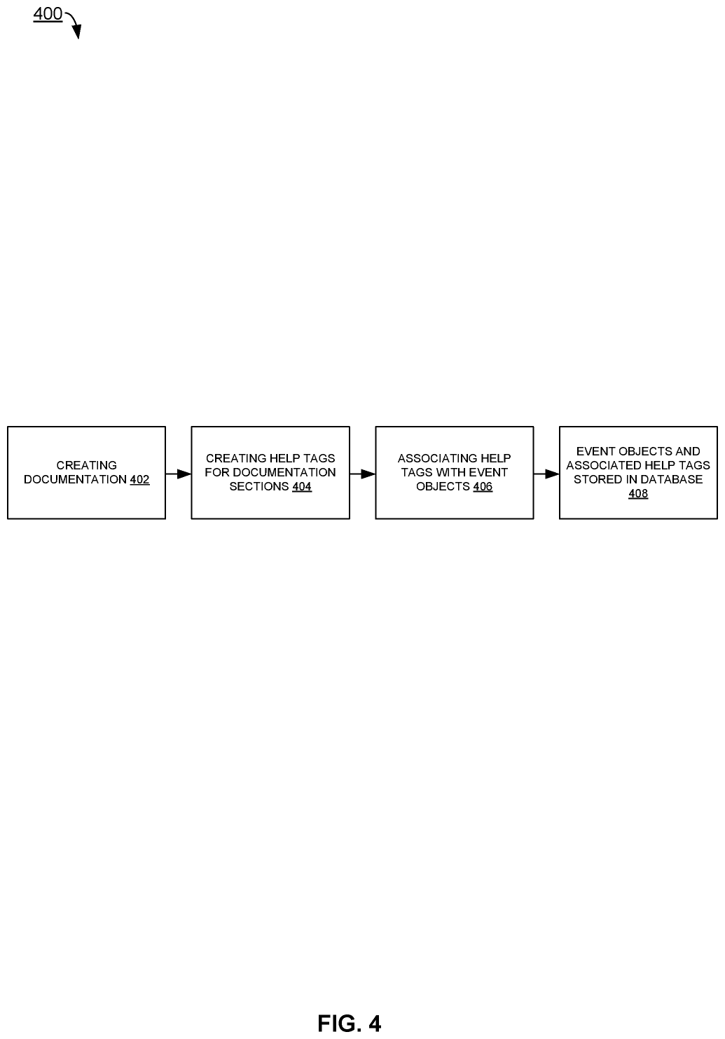

FIG. 4 illustrates an example system architecture 400 for smart documentation setup flow, and a tags creation and association process, that can facilitate smart online documentation, in accordance with an embodiment of this disclosure. In some examples, part(s) of system architecture 400 can be implemented by smart online documentation component 108 of FIG. 1.

System architecture 400 comprises creating documentation 402; creating help tags for documentation sections 404; associating help tags with event objects 406; and event objects and associated help tags stored in database 408.

Creating documentation 402 can comprise receiving user input data indicative of the documentation content from a user account.

Creating help tags for documentation sections 404 can comprise receiving user input data associated with identifying particular help tags for particular sections of documentation created in creating documentation 402. Associate help tags with event objects 406 can comprise receiving user input data associated with correlating particular help tags with particular types of user events that users can perform. In some examples, creating help tags for documentation sections 404, and associating help tags with event objects 406 can be performed automatically using auto-tagging technology.

Event objects and associated help tags stored in database 408 can comprise storing respective associations between events and help tags in a database that is accessible by smart online documentation component 108 of FIG. 1 to facilitate smart online documentation.

In some examples, there can be a smart documentation setup process in place for documentation and events, as depicted in system architecture 400.

After the documentation is written (e.g., in 402), help tags can be defined for content within the documentation and for different sections within the documentation (e.g., in 404).

Example help tags can include tags such as storage, setup, quick start, novice, expert, objectABC, troubleshooting, etc.

Then, help tags can be associated with events and objects that are associated with the corresponding product (e.g., in 406). Events such as “node disconnected” and objects such as “power switch ABC” can be associated with help tags such as “node disconnected,” and “power switch ABC,” respectively.

The following event can be triggered: “power switch ABC and power switch OPQ are disconnected,” Then the associated help tags for this triggered event can be “power switch” and “disconnect,” along with reference to specific objects “power switch ABC” and “power switch OPQ.” These help tags can be captured and stored in a database for future analysis (e.g., in 408).

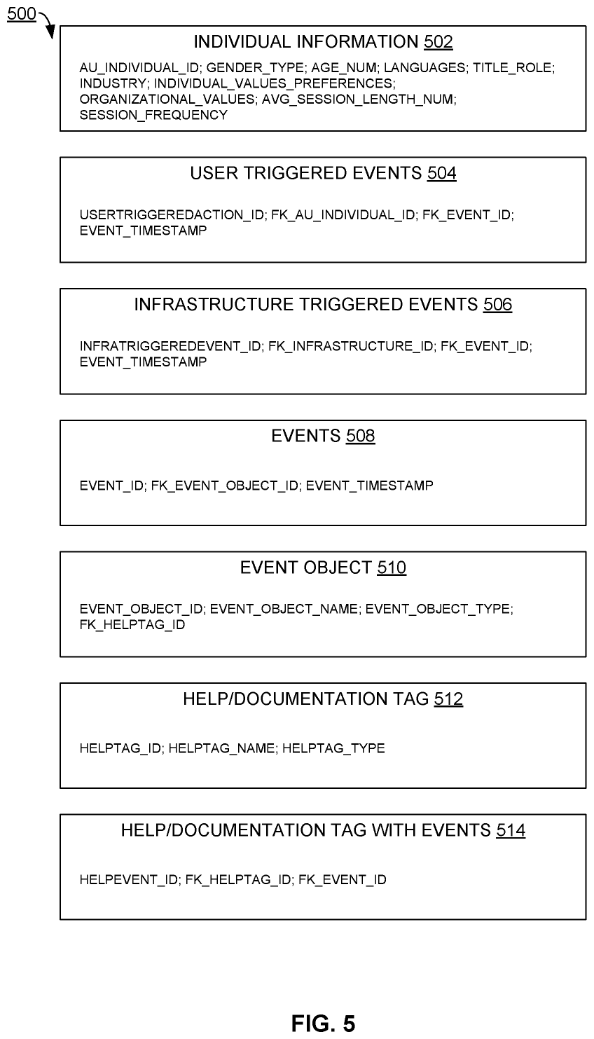

FIG. 5 illustrates another example system architecture 500 that can facilitate smart online documentation, in accordance with an embodiment of this disclosure. In some examples, part(s) of system architecture 500 can be implemented by smart online documentation component 108 of FIG. 1. In some examples, system architecture 500 can comprise a relational database schema.

Each event and event object can have associated help tags. Sections and subsections of documentation can also be associated with help tags and help tags events. This information can be stored in a database for later filtering and analysis.

System architecture 500 comprises authenticated individual information 502; user triggered events 504; infrastructure triggered events 506; events 508; event object 510; help/documentation tag 512; and help/documentation tag with events 514.

Authenticated individual information 502; user triggered events 504; infrastructure triggered events 506; events 508; and event object 510 can be classified as product tables. Help/documentation tag 512; and help/documentation tag with events 514 can be classified as help/documentation tables.

Authenticated individual information 502 can comprise database table fields such as Au Individual ID; Gender Type; Age Num; Languages; Title Role; Industry; Individual Values Preferences; Organizational values; Avg Session Length Num; and Session Frequency.

User triggered events 504 can comprise database table fields such as UserTriggeredAction ID; FK Au Individual ID; FK Event ID; and Event_Timestamp. Infrastructure triggered events 506 can comprise database table fields such as InfraTriggeredEvent ID; FK Infrastructure ID; FK Event ID; and Event_Timestamp.

Events 508 can comprise database table fields such as Event ID; FK Event Object ID; and Event_Timestamp.

Event object 510 can comprise database table fields such as Event Object ID; Event Object Name; Event Object Type; and FK HelpTag ID.

Help/documentation tag 512 can comprise database table fields such as HelpTag ID; HelpTag Name; and HelpTag Type. Help/documentation tag with events 514 can comprise information such as HelpEvent ID; FK HelpTag ID; and FK Event ID.

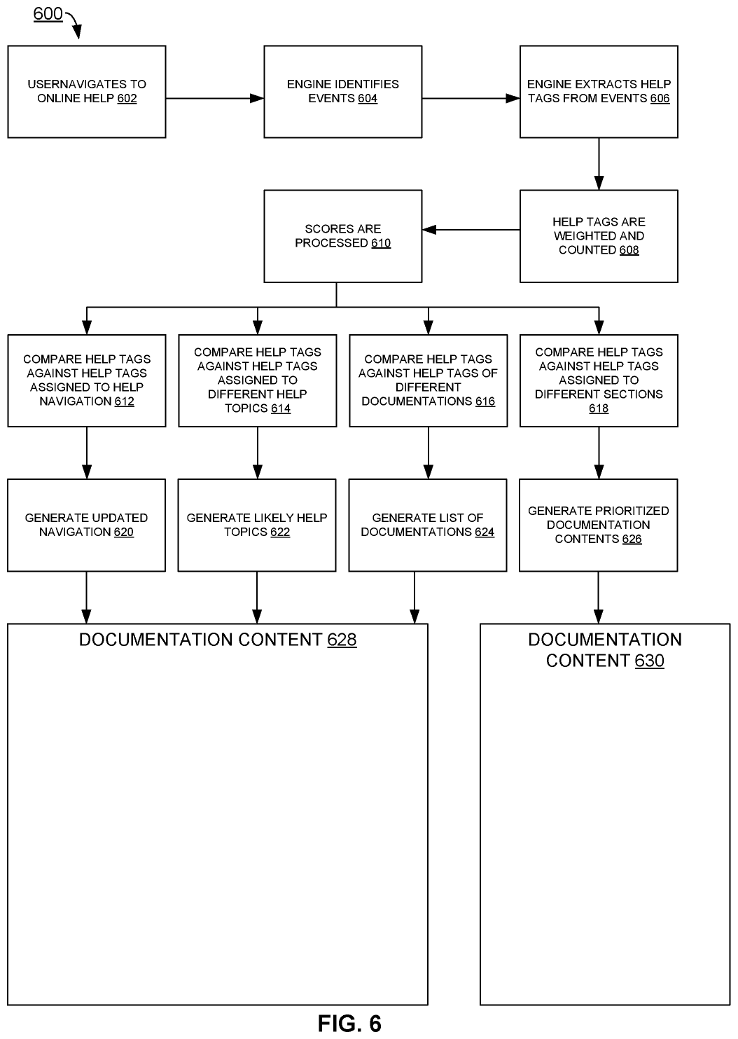

FIG. 6 illustrates an example system architecture 600 for a smart online documentation backend that can facilitate smart online documentation, in accordance with an embodiment of this disclosure. In some examples, part(s) of system architecture 600 can be implemented by smart online documentation component 108 of FIG. 1.

System architecture comprises user navigates to online help 602; engine identifies events 604; engine extracts help tags from events 606; help tags are weighted and counted 608; scores are processed 610; compare help tags against help tags assigned to help navigation 612; compare help tags against help tags assigned to different help topics 614; compare help tags against help tags assigned to different documentations 616; compare help tags against help tags assigned to different sections 618; generate updated navigation 620; generate likely help topics 622; generate list of documentations 624; generate prioritized documentation contents 626; documentation content 628; and documentation content 630.

Engine identifies events 604 can comprise an engine identifying events in a reverse chronological order before user navigates to online help 602 occurs. Help tags are weighted and counted 608 can comprise weighing and counting based on different factors, such as chronological order and frequency.

Scores are processed 610 can comprise matching documentation topics with help topics based on the scores, where higher scoring tags lead to higher-prioritized documentation.

Compare help tags against help tags assigned to different sections 618 can comprise doing so for sections within a help content database.

Generate updated navigation 620 can be similar to smart documentation engine generates updated navigation of the help page 314 of FIG. 3. Generate likely help topics 622 can be similar to smart documentation engine generates list of likely topics 316. Generate list of documentations 624 can be similar to smart documentation engine generates list of documentations 318. Generate prioritized documentation contents 626 can be similar to smart documentation engine generates documentation with content prioritization 320. Documentation content 628 can be similar to online documentation help 302. Documentation content 630 can be similar to online documentation 310.

When a user navigates to online documentation, it can be that, before anything is rendered to the screen, a backend process (such as one implemented by system architecture 600) can identify events in reverse chronological order. This backend process can extract help tags from identified events, and these help tags can be weighted and counted based on various factors (e.g., chronological order, frequency, etc.).

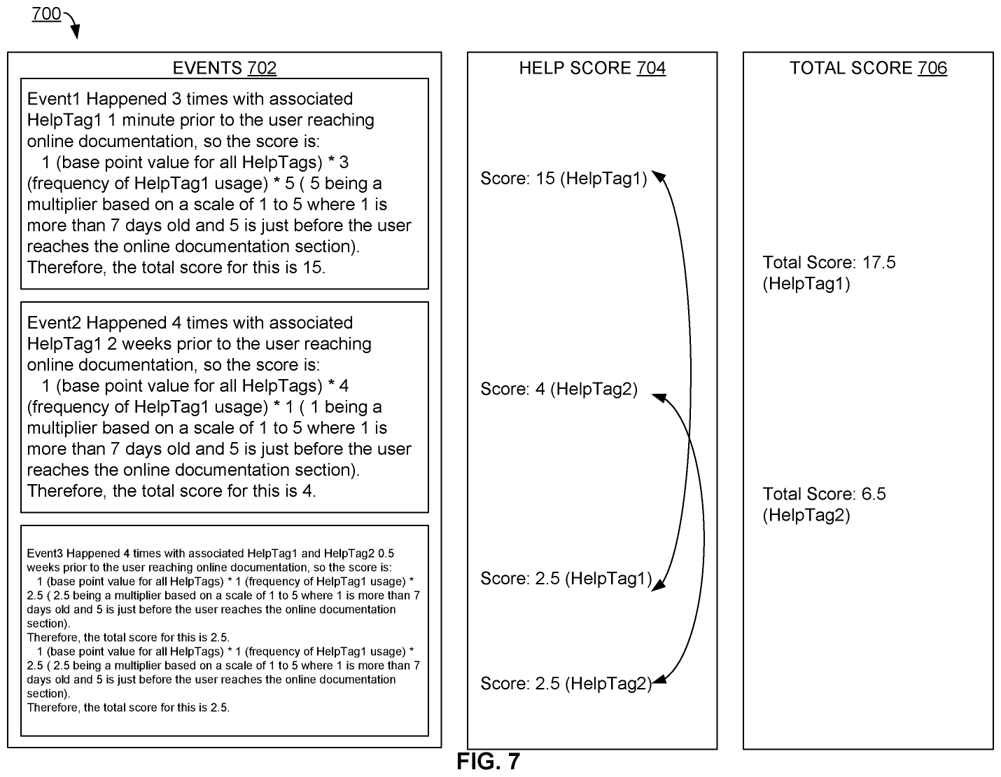

FIG. 7 illustrates an example system architecture 700 for determining a score that can facilitate smart online documentation, in accordance with an embodiment of this disclosure. In some examples, part(s) of system architecture 700 can be implemented by smart online documentation component 108 of FIG. 1.

System architecture 700 comprises events 702, help score 704, and total score 706.

In an example, Eventl Happened 3 times with associated HelpTagl 1 minute prior to the user reaching online documentation, so the score is: 1 (base point value for all HelpTags)*3 (frequency of HelpTagl usage)*5 (5 being a multiplier based on a scale of 1 to 5 where 1 is more than 7 days old and 5 is just before the user reaches the online documentation section). Therefore, the total score in this example is 15.

In another example, a base point value can be 2 when a HelpTag is labeled as Critical. Using the above example with this modification:

2 (base point value for Critical HelpTag)*3 (frequency of Critical usage)*5 (5 being a multiplier based on a scale of 1 to 5 where 1 is more than 7 days old and 5 is just before the user reaches the online documentation section). Therefore, the total score in this example is 30.

Similar determinations can be performed for other events. Accumulated and aggregated help tag scores can be ranked and passed into a smart online documentation backend engine for processing, matching, and prioritizing against different documentation prioritizations, including navigation items, topics, articles, and sections.

### Example Process Flows

FIG. 8 illustrates an example process flow 800 that can facilitate smart online documentation, in accordance with an embodiment of this disclosure. In some examples, one or more embodiments of process flow 800 can be implemented by smart online documentation component 108 of FIG. 1, or computing environment 1100 of FIG. 11.

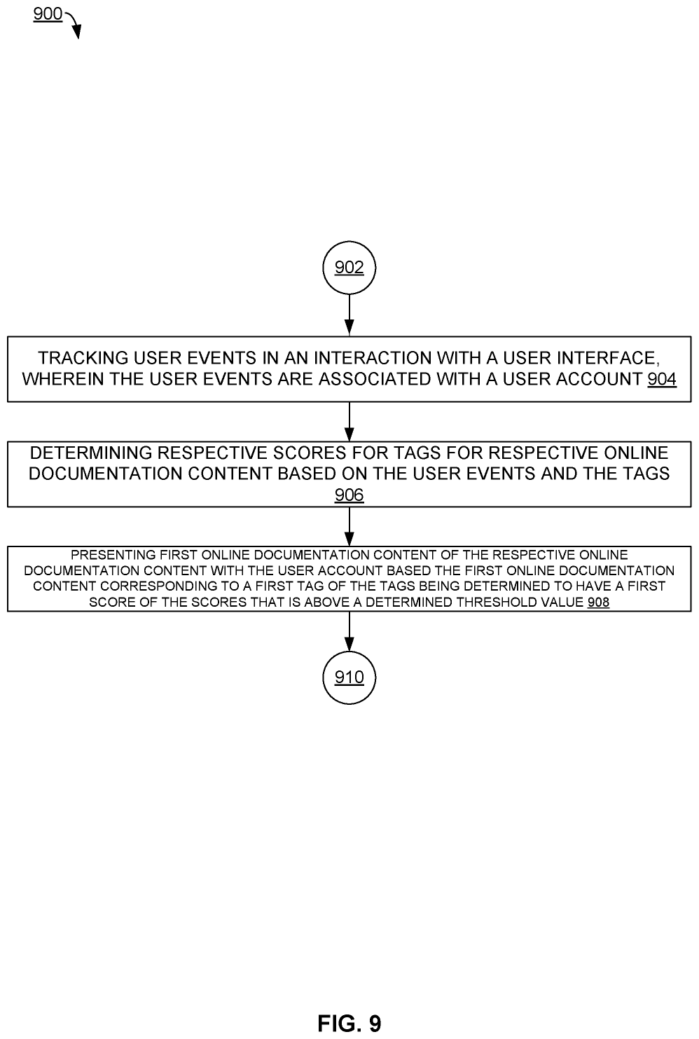

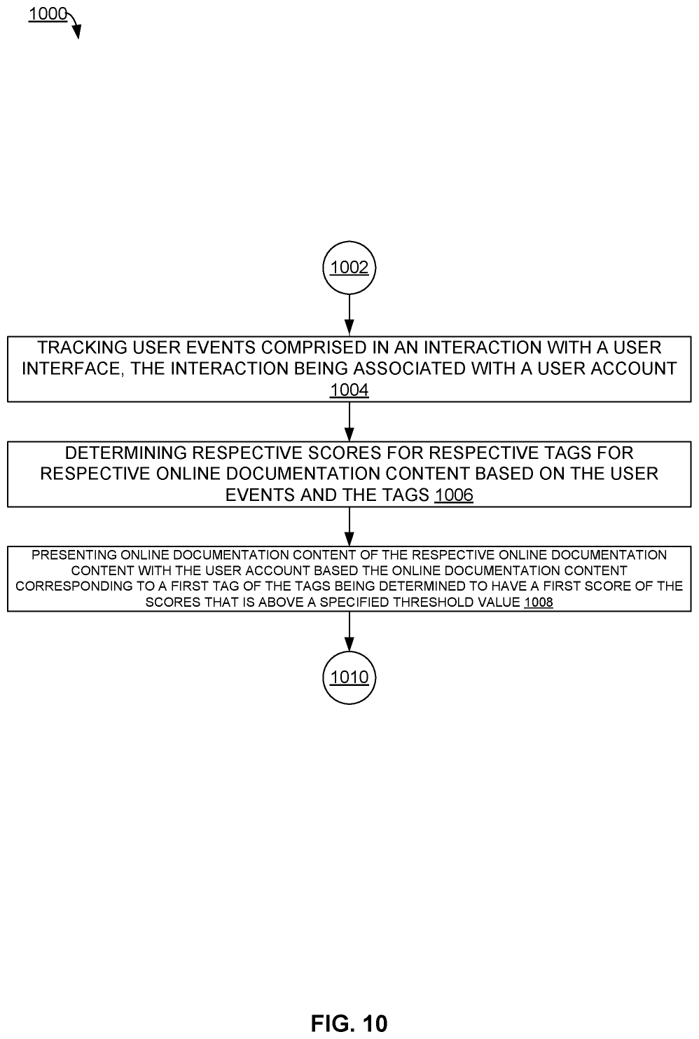

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 900 of FIG. 9, and/or process flow 1000 of FIG. 10.

Process flow 800 begins with 802, and moves to operation 804.

Operation 804 depicts associating respective tags with respective online documentation content. In some examples, this can comprise associating respective tags with respective online documentation content and document sections/navigation.

In some examples, this can be implemented in a similar manner as associate events with help tags 212 of FIG. 2.

After operation 804, process flow 800 moves to operation 806.

Operation 806 depicts tracking user events in interacting with a user interface, wherein the user events are associated with a user account. In some examples, this can be implemented in a similar manner as users conduct actions/events 202 of FIG. 2, where smart online documentation component 108 of FIG. 1 tracks these actions/events.

After operation 806, process flow 800 moves to operation 808.

Operation 808 depicts determining respective scores for the respective tags based on the user events and the respective tags. In some examples, this can comprise determining respective scores for the respective tags based on the user events, user actions/events, and the respective tags. In some examples, this can be implemented in a similar manner as identify relevant event help tags 214 of FIG. 2.

In some examples, a first user event of the user events is associated with a first tag of the respective tags and a second tag of the respective tags, and operation 808 comprises determining a second score for the first tag for the first event, and determining a third score for the second tag for the first event. That is, an event can be associated with multiple tags, and a score for each tag can be determined when evaluating that event.

In some examples, operation 808 comprises quantifying respective frequencies of types of the user events. In some examples, operation 808 comprises weighting respective frequencies of types of the user events. In some examples, operation 808 comprises quantifying a chronology the user events. In some examples, operation 808 comprises weighting a chronology the user events. That is, user event types or chronologies can be quantified and/or weighted.

In some examples, a first user event of the user events is associated with a first tag of the respective tags, and is associated with a second tag of the respective tags. That is, one event can be associated with multiple tags.

In some examples, a first user event of the user events is associated with a first tag of the respective tags, and wherein a second user event of the user events is associated with the first tag. That is, one tag can be associated with each of multiple different events.

In some examples, the respective tags are assigned respective base point values, and determining the respective scores is performed based on the respective base point values. That is, a tag can have an assigned base point value, such as depicted in system architecture 700 of FIG. 7.

After operation 808, process flow 800 moves to operation 810.

Operation 810 depicts presenting first online documentation content of the respective online documentation content with the user account based the first online documentation content corresponding to a first tag of the respective tags having a first score of the respective scores that is determined to be above a defined threshold value. In some examples, this can be implemented in a similar manner as arrange documentation sections 220 of FIG. 2. In some examples, a defined threshold value can be the content that is deemed most-relevant for presentation to the user account.

After operation 810, process flow 800 moves to 812, where process flow 800 ends.

FIG. 9 illustrates an example process flow 900 that can facilitate smart online documentation, in accordance with an embodiment of this disclosure. In some examples, one or more embodiments of process flow 900 can be implemented by smart online documentation component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904.

Operation 904 depicts tracking user events in an interaction with a user interface, wherein the user events are associated with a user account. In some examples, operation 904 can be implemented in a similar manner as operation 806 of FIG. 8.

In some examples, operation 904 comprises, in response to determining that the user account initiates a new session of accessing the user interface, determining a most-recent event of the user events that is associated with the user account, wherein determining the respective scores for the respective online documentation content is based on the most-recent event. In some examples, operation 904 comprises maintaining respective timestamps for respective user events of the user events, and wherein determining the most-recent event of the user events is performed based on the respective timestamps. That is, when online documentation is opened, events can be checked for based on a time stamp process to determine a last action that the user account performed before the time stamp where the user account accesses the help documentation. This particular event (the last action before help) can be assigned a higher weight.

After operation 904, process flow 900 moves to operation 906.

Operation 906 depicts determining respective scores for respective tags for online documentation content based on the user events and the tags. In some examples, this can comprise determining respective scores for respective tags for online documentation content and documentation sections/navigation based on the user events and the tags.

In some examples, operation 906 can be implemented in a similar manner as operation 808 of FIG. 8.

In some examples, operation 906 comprises storing associations between respective tags of the tags and respective types of the user events to produce stored associations, wherein the stored associations are indicated based on received user input data, where determining the respective scores for the respective online documentation content is based on the stored associations. That is, an administrator can provide user input that defines these tags and associations.

After operation 906, process flow 900 moves to operation 908.

Operation 908 depicts presenting first online documentation content of the online documentation content with the user account based the first online documentation content corresponding to a first tag of the tags being determined to have a first score of the scores that is above a determined threshold value. In some examples, operation 908 can be implemented in a similar manner as operation 810 of FIG. 8.

In some examples, operation 908 comprises modifying a content of a navigation portion of the first online documentation content in a user interface in which the first online documentation content is presented. That is, a documentation page's navigation can be adjusted to promote the right content to meet a particular user's need and expertise level. For example, relevant topics can move to the top.

In some examples, operation 908 comprises presenting a hyperlink to the first online documentation content in a predefined location within the user interface. That is, Top potential topics that the users might care about can be promoted front and center. For example, hyperlinks to top three suggested help topics can be automatically generated.

In some examples, operation 908 comprises presenting the first online documentation content via the user account before presenting second online documentation content of the respective online documentation content via the user account. That is, documentation articles can be prioritized based on the selected topics in sequence of relevance. For example, a list of articles related to suggested help topics can be presented on the home screen.

In some examples, operation 908 comprises determining the respective scores based on an expertise level associated with the user account or an identified request associated with the user account. That is, selected documentation content can be prioritized based on a user's console usage, needs, and expertise level. For example, the documentation page for a specific alert type can prioritize the introductory content section and deprioritize advanced content section(s) because based on analytics, the user is likely looking for basic level support.

After operation 908, process flow 900 moves to 910, where process flow 900 ends.

FIG. 10 illustrates an example process flow 1000 that can facilitate smart online documentation. In some examples, one or more embodiments of process flow 1000 can be implemented by smart online documentation component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 800 of FIG. 8, and/or process flow 900 of FIG. 9.

Process flow 1000 begins with 1002, and moves to operation 1004.

Operation 1004 depicts tracking user events comprised in an interaction with a user interface, the interaction being associated with a user account. In some examples, operation 1004 can be implemented in a similar manner as operation 806 of FIG. 8.

In some examples, a first user event of the user events comprises an infrastructure event, a console event, or data indicative of a manual action event. That is, operations can be performed to define help tags associated with all usage events in a console, including infrastructure events, console events, and manual (user-triggered) action events.

After operation 1004, process flow 1000 moves to operation 1006.

Operation 1006 depicts determining respective scores for respective tags for respective online documentation content based on the user events and the tags. In some examples, operation 1006 can be implemented in a similar manner as operation 808 of FIG. 8.

After operation 1006, process flow 1000 moves to operation 1008.

Operation 1008 depicts presenting online documentation content of the respective online documentation content with the user account based the online documentation content corresponding to a first tag of the tags being determined to have a first score of the scores that is above a specified threshold value. In some examples, operation 1008 can be implemented in a similar manner as operation 1010 of FIG. 8.

In some examples, the online documentation content comprises general navigation content, or a top documentation topic. In some examples, the online documentation content comprises a link to documentation, or a content section within a documentation page. That is, the present techniques can be implemented to improve online documentation by matching and prioritizing appropriate general navigation, top documentation topics, links to documentation, and specific content sections within documentation pages to match users intent and circumstances.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of server 102, communications network 104, and/or user computer 106 of FIG. 1.

In some examples, computing environment 1100 can implement one or more embodiments of the process flows of FIGS. 8-10 to facilitate smart online documentation.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a processor; and
a memory coupled to the processor, comprising instructions that cause the processor to perform operations comprising:
associating respective tags with respective online documentation content;
tracking user events in interacting with a user interface, wherein the user events are associated with a user account;
determining respective scores for the respective tags based on the user events and the respective tags, wherein the respective scores are determined based on a combination of respective base point values associated with the respective tags, respective frequencies of respective user events of the user events, and respective times when the respective user events occurred; and
selecting first online documentation content of the respective online documentation content with the user account based the first online documentation content corresponding to a first tag of the respective tags having a first score of the respective scores that is determined to be above a defined threshold value;
modifying the first online documentation content based on an expertise level associated with the user account, to produce a modified first online documentation; and
presenting the modified first online documentation.

2. The system of claim 1, wherein a first user event of the user events is associated with the first tag, and is associated with a second tag of the respective tags.

3. The system of claim 1, wherein a first user event of the user events is associated with the first tag, and wherein a second user event of the user events is associated with the first tag.

4. (canceled)

5. The system of claim 1, wherein a first user event of the user events is associated with the first tag and a second tag of the respective tags, and wherein determining the respective scores comprises:
determining a second score for the first tag for the first user event; and
determining a third score for the second tag for the first user event.

6. (canceled)

7. The system of claim 1, wherein determining the respective scores for the respective tags based on the user events and the respective tags comprises:
weighting respective frequencies of types of the user events.

8. The system of claim 1, wherein determining the respective scores for the respective tags based on the user events and the respective tags comprises:
quantifying the respective times when the respective user events occurred.

9. The system of claim 1, wherein determining the respective scores for the respective tags based on the user events and the respective tags comprises:
weighting the respective times when the respective user events occurred.

10. A method, comprising:
tracking, by a system comprising a processor, user events in an interaction with a user interface, wherein the user events are associated with a user account;
determining, by the system, respective scores for respective tags for online documentation content based on the user events and the tags, wherein the respective scores are determined based on a combination of respective base point values associated with the respective tags, respective frequencies of respective user events of the user events, and respective times when the respective user events occurred;
selecting, by the system, first online documentation content of the online documentation content with the user account based the first online documentation content corresponding to a first tag of the tags being determined to have a first score of the scores that is above a determined threshold value;
modifying, by the system, the first online documentation content based on an expertise level of the user account, to produce a modified first online documentation; and
presenting the modified first online documentation.

11. The method of claim 10, further comprising:
in response to determining that the user account initiates a new session of accessing the user interface, determining, by the system, a most-recent event of the user events that is associated with the user account, wherein determining the respective scores for the respective tags is based on the most-recent event.

12. The method of claim 11, further comprising:
maintaining, by the system, respective timestamps for respective user events of the user events, and wherein determining the most-recent event of the user events is performed based on the respective timestamps.

13. The method of claim 10, further comprising:
storing, by the system, associations between respective tags of the tags and respective types of the user events to produce stored associations, wherein the stored associations are indicated based on received user input data; and
wherein determining the respective scores for the respective tags is based on the stored associations.

14. The method of claim 10, wherein presenting the first online documentation content comprises:
modifying, by the system, a content of a navigation portion of the first online documentation content in a user interface in which the first online documentation content is presented.

15. The method of claim 10, wherein presenting the first online documentation content comprises:
presenting, by the system, a hyperlink to the first online documentation content in a predefined location within the user interface.

16. The method of claim 10, wherein presenting the first online documentation content comprises:
presenting the first online documentation content via the user account before presenting second online documentation content of the respective online documentation content via the user account.

17. (canceled)

18. A non-transitory computer-readable medium comprising instructions that, in response to execution, cause a system comprising a processor to perform operations, comprising:
tracking user events comprised in an interaction with a user interface, the interaction being associated with a user account;
determining respective scores for respective tags for respective online documentation content based on the user events and the tags, wherein the respective scores are determined based on a combination of respective base point values associated with the respective tags, respective frequencies of respective user events of the user events, and respective times when the respective user events occurred;
identifying online documentation content of the respective online documentation content with the user account based the online documentation content corresponding to a first tag of the tags being determined to have a first score of the scores that is above a specified threshold value;
modifying the online documentation content based on an expertise level of the user account, to produce a modified first online documentation; and
presenting the modified first online documentation.

19. The non-transitory computer-readable medium of claim 18, wherein a first user event of the user events comprises an infrastructure event, a console event, or data indicative of a manual action event.

20. The non-transitory computer-readable medium of claim 18, wherein the online documentation content comprises general navigation content, a top documentation topic, a link to documentation, or a content section within a documentation page.

21. The system of claim 1, wherein the combination of the respective base point values associated with the respective tags, the respective frequencies of the respective user events of the user events, and the respective times when the respective user events occurred comprises a multiplication of the respective base point values, first respective numeric values associated with the respective frequencies, and second respective numeric values associated with the respective times.

22. (canceled)

23. The method of claim 10, wherein the combination of the respective base point values associated with the respective tags, the respective frequencies of respective user events of the user events, and the respective times when the respective user events occurred comprises a multiplication of the respective base point values, first respective numeric values associated with the respective frequencies, and second respective numeric values associated with the respective times.

24. The non-transitory computer-readable medium of claim 18, wherein the combination of the respective base point values associated with the respective tags, the respective frequencies of respective user events of the user events, and the respective times when the respective user events occurred comprises a multiplication of the respective base point values, first respective numeric values associated with the respective frequencies, and second respective numeric values associated with the respective times.
